(19) United States
(12) Patent Application Publication
(10) Pub. No.: US 2003/0003274 A1
(43) Pub. Date: Jan. 2, 2003

(54) Procedure And Press For Producing Screening And Humidifying Panels In Particular For Avicultural Facilities Or Greenhouses And Panels Produced By This Procedure

(76) Inventor: Antonio Gigola, BRESCIA (IT)

Correspondence Address: Philip K Fitzsimmons, Shlesinger Fitzsimmons & Shlesinger, 183 East Main Street, 1323 Alliance Building, ROCHESTER, NY, 14604, US

(21) Appl. No.: 09/482,046

(22) Filed: Jan. 13, 2000

(30) Foreign Application Priority Data
Jan. 15, 1999 (IT) MI 99 A 000073

(51) Int. Cl. B32B 3/00

(52) U.S. Cl. 428/174

(57) ABSTRACT

A process for manufacturing screening and humidifying panels in particular for air circulation in avicultural facilities or greenhouses comprises the steps of shaping cardboard sheets with non-rectilinear undulated channels by. means of sequential pressing of the individual channels and gluing together of the sheets arranged with alternating different mutual inclination of the channels. To realize the process a press comprising a die made up of a plurality of segments each representing al least part of a channel and moving sequentially to press the cardboard starting from one end of the press is proposed.

### BACKGROUND OF THE INVENTION

The present invention relates to a method for producing screening and humidifying panels in particular for avicultural facilities or greenhouses and a panel produced by this procedure and equipment for this method.

In the field there are known honeycombed panels with channels extending between the two faces of the panel to allow air passage. There are predominantly two types of panels, to wit screening panels in which the channels are provided so as not to have the two ends aligned and thus prevent or reduce light inlet, and humidifying panels in which are made passages between the channels to permit continuous falling of a water veil to humidify the air passing through the channels.

Screening panels can be made of any material and in general plastic is preferred so as to press easily the channels with the necessary non-rectilinear configuration.

Humidifying panels require to be made from moderately absorbent and porous materials to obtain a moist surface as broad as possible in contact with the air. The preferred material is impregnated cardboard which has been found to give the best characteristics in the particular application. Panels are accordingly made from glued cardboard layers appropriately undulated to form air channels and water passages. Unfortunately, by the known techniques it is impossible to make undulated cardboard with non-rectilinear undulations. For this reason the channels of the panels made in this manner are also rectilinear and it is accordingly impossible to make humidifying panels having screening properties also.

Another problem is that the undulations can be produced continuously only in a direction near the transversal direction of the cardboard strip. This prevents obtaining panels having the inclinations which would be preferable for a more uniform distribution of the water veil. In addition the undulated cardboard layers forming the water passages should have the undulations with extension nearly right above the panel. Such a direction is however also that of maximum transversal extension of the panel. Since the extension of the cardboard in the direction parallel to the undulations coincides with the transversal extension of the cardboard strip during production of the undulations it is difficult and costly to make larger panels.

The general purpose of the present invention is to remedy the above mentioned shortcomings by making available a production method which would make it possible to obtain cardboard panels with both screening and humidifying functions and in addition with the humidifying function incremented with respect to that of the prior art panels.

Again in accordance with the purposes of the present invention there is supplied a panel made in accordance with said method and tools for the method.

### SUMMARY OF THE INVENTION

In view of this purpose it was sought to provide in accordance with the present invention a process for manufacturing screening and humidifying panels in particular for avicultural facilities or greenhouses comprising the steps of shaping the cardboard sheets with non-rectilinear undulated channels by means of sequential pressing of the individual channels and gluing together of the sheets arranged with alternating different mutual inclination of the channels.

Again in view of the above mentioned purposes it is sought to make a screening and humidifying panel in particular for avicultural facilities or greenhouses made up of cardboard sheets shaped by means of pressure with non-rectilinear undulated channels glued together arranged with different mutual alternating inclination of the channels.

Furthermore it is sought to make a press for obtaining deformed cardboard sheets with channels for manufacturing screening and humidifying panels in particular for avicultural facilities or greenhouses and comprising a bottom die made up of a plurality of segments with each one representing at least part of a channel and movable sequentially for pressing the cardboard starting from one end of the press.

### BRIEF DESCRIPTION OF THE DRAWINGS

To clarify the explanation of the innovative principles of the present invention and its advantages compared with the prior art there is described below with the aid of the annexed drawings a possible embodiment thereof by way of non-limiting example applying said principles. In the drawings:

FIG. 1 shows a diagrammatic perspective view of a panel in accordance with the present invention,

FIG. 2 shows a plan view of a layer of the panel,

FIG. 3 shows a partially cross sectioned side view of the panel,

FIG. 4 shows a diagrammatic side elevation of a press for obtaining layers in accordance with the present invention,

FIGS. 5 and 6 shows views similar to FIG. 2 but of variant embodiments, and

FIG. 7 shows a diagrammatic view of a second embodiment of a press in accordance with the present invention.

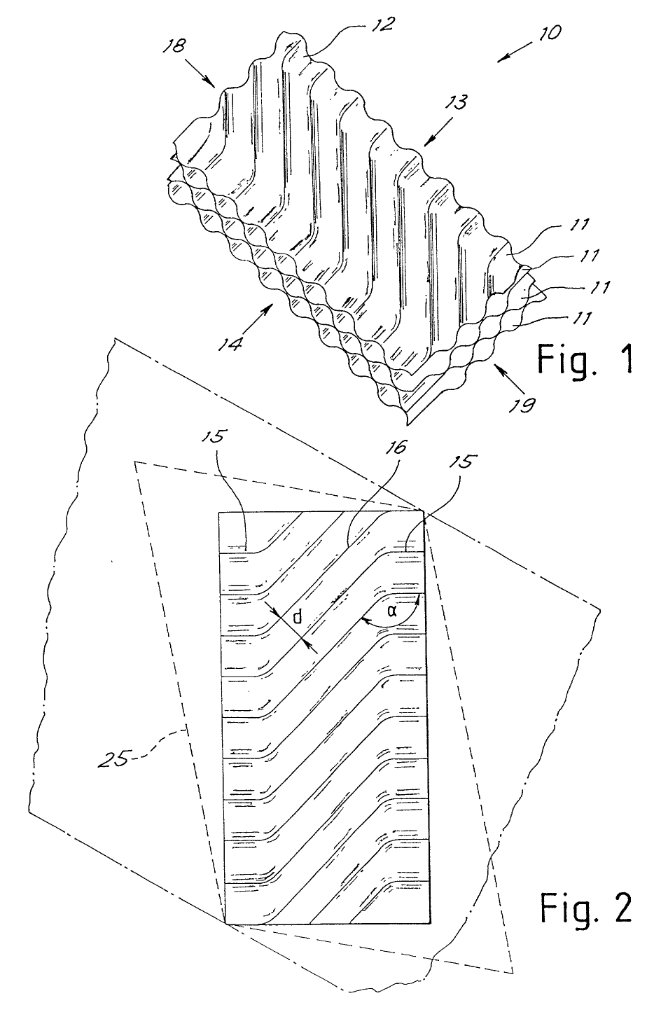

### DETAILED DESCRIPTION OF THE INVENTION

With reference to the FIGS a panel 10 is made up of a plurality of layers of sheets 11 of cardboard impregnated e.g. with resin and glued together. Each sheet has shaped on it channels or undulations 12.

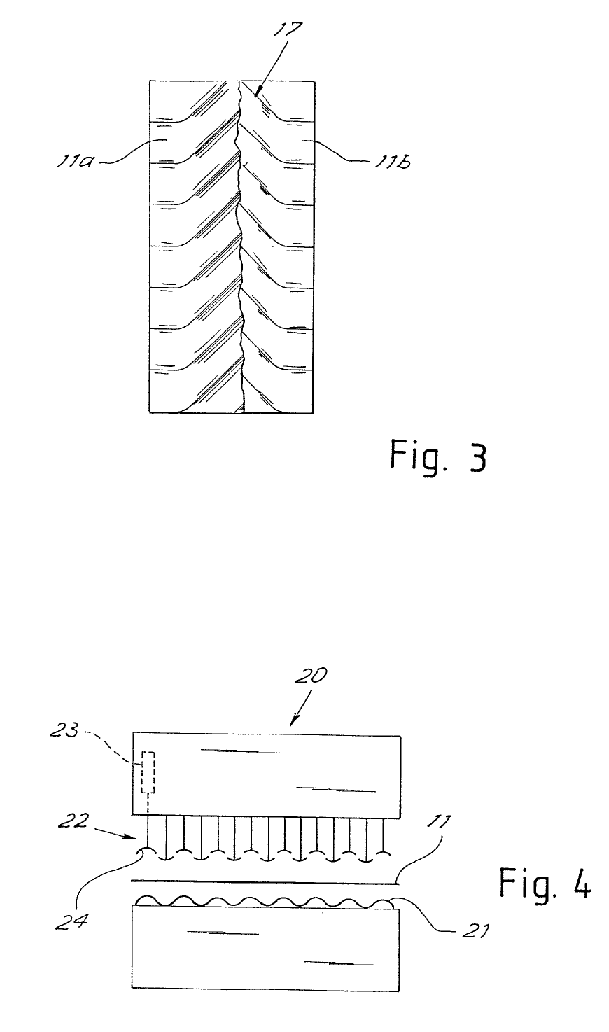

As may be seen in FIG. 2 each of the channels 12 has end sections 15 which are near the edges of the sheet which coincide with the two faces 13, 14 for inlet & outlet of air into or from the panel. The sections 15 are basically at a right angle to the sheet edges and are connected by a section of channel 16 inclined so that the mouths of the channels are not in view of each other along the channel axis. The screening function is obtained in this manner. The angle α can be e.g. around 130°. The undulations can have a height of approximately 7 mm and the distance d between the crests can be approximately 21 mm. As may be seen in FIG. 3 neighboring sheets (indicated in the FIG by reference numbers 11a and 11b) are arranged overturned with respect to each other so that the channels on the two sheets have opposing inclinations. The contact points between the channel crests of the two sheets are glued to form the panel.

In this manner there are obtained channels for conveying the air between the faces 13 and 14 of the panel and the passages 17 which connect the air conveyance channels together and extend between the upper and lower faces 18, 19 of the panel. From the upper face water can thus be inlet to form a veil over all the walls of the sheets. The air humidification function is obtained thus. Thanks to the peculiar form of the channels distribution uniformity and exchange efficiency are much higher than those of conventional panels.

To be able to deform the cardboard to obtain the channels it has been found necessary to press the undulations on each sheet in sequence starting from one end. This is necessary to allow the cardboard to deform without tearing.

FIG. 4 shows diagrammatically a heated press 20 which obtains that. It comprises a base equipped with a die 21 reproducing the form to be obtained on the cardboard and a segmented moving die 22 with each segment 24 defining a channel. The segments are operated by actuators 23 (only one is shown) to be able to descend on the die 21 in sequence starting from one end to reach the other end of the press. Once all the segments have descended the press can remain closed for the time necessary for permanent deformation of the cardboard.

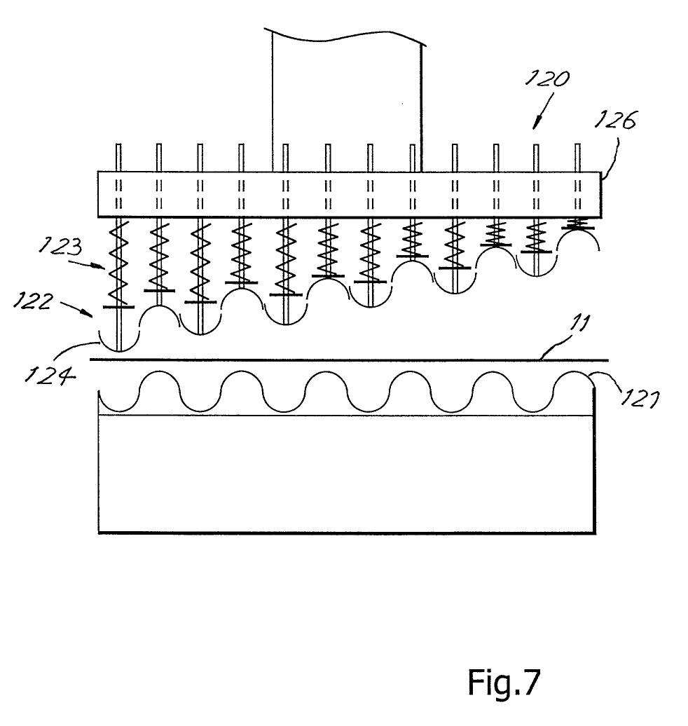

FIG. 7 shows a possible alternative embodiment of a press in accordance with the present invention. A press 120 comprises a base with a die 121 reproducing the form to be obtained on the cardboard. The upper movable press table 126 supports a segmented movable die 122 in which each segment 114 is connected to the upper table 126 through an elastically yielding member 123, e.g. a spring. The segments 124 are arranged at a growing distance from the table 121 starting from one end and moving towards the other end of the undulated table. In this manner, upon operation of the press the segments 124 close sequentially on the table 121 to deform the cardboard sheet 11. The elastic members are chosen to have sufficient elastic force to produce the correct compression of the cardboard without obstructing press closing. With a single command it is thus possible to obtain sequential deformation of the sheet 11.

The initial profile of the cardboard sheet to be shaped must allow for the deformation produced by the press. FIG. 2 shows how the sheet should have a lozenge form 25 to become rectangular after forming.

Surprisingly it has been found that the sequential forming permits deformation in accordance with non-rectilinear undulations without tearing the cardboard.

It is now clear that the predetermined purposes have been achieved by making available a production method and a panel allowing obtaining both the screening function and the humidifying function.

Naturally the above description of an embodiment applying the innovative principles of the present invention is given by way of non-limiting example of said principles within the scope of the exclusive right claimed here.

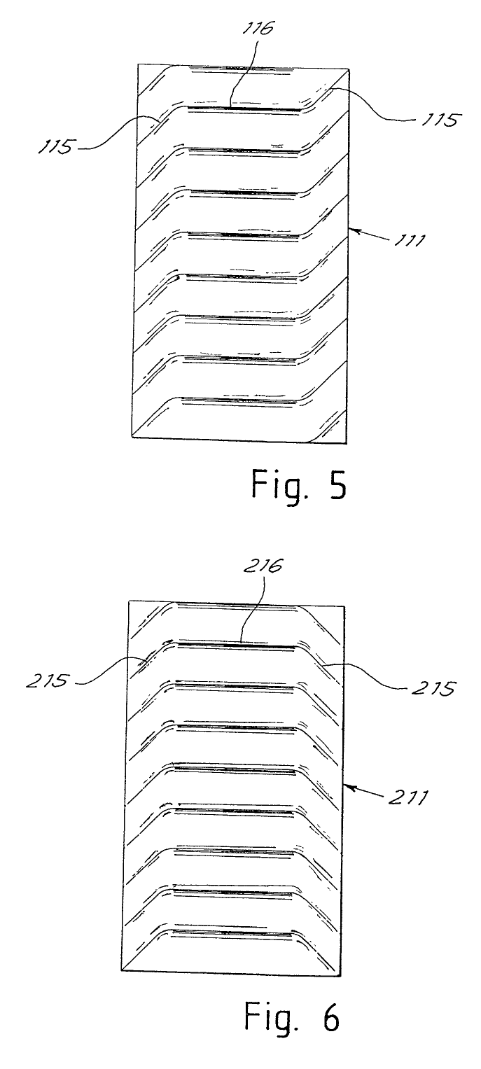

For example the extension of the panel in all directions and the number of component layers will vary depending on specific requirements. The sheet forming process can also be accomplished by steps with a continuous strip of cardboard extending directly in the direction of greatest contraction caused by the forming as shown in broken lines in FIG. 2. The sheets will be trimmed after forming. The configuration of the channels can be different than shown while preserving the screening characteristics. For example FIG. 5 shows a panel layer indicated by reference number 111 having channels with initial and final parts 115 inclined in matching manner and the central part 116 at a right angle to the air inlet-outlet edge. FIG. 6 shows another embodiment of a layer 211 in which the channels have initial and final parts 215 inclined in opposite direction and the central part 216 at a right angle to the air inlet and outlet edge. Both embodiments can be pressed by the method in accordance with the present invention.

What is claimed is:

1. Process for manufacturing screening and humidifying panels and in particular for avicultural facilities or greenhouses comprising the steps of shaping the cardboard sheets with non-rectilinear undulated channels by means of sequential pressing of the individual channels and gluing together of the sheets arranged with alternating different mutual inclination of the channels.

2. Process in accordance with claim 1 wherein each channel has end sections near the edges of the sheet which will constitute inlet outlet sides of the panel and which are virtually at a right angle to said edges and inclined sections for connection of said end sections.

3. Process in accordance with claim 1 wherein each channel has end sections near the edges of the sheet which will constitute inlet outlet sides of the panel and which are inclined with respect to said edges and sections virtually at a right angle to said edges for connection of said end sections.

4. Process in accordance with claim 1 wherein pressing takes place by means of a plurality of die sections each representing at least part of a channel and moved to press the cardboard sequentially.

5. Process in accordance with claim 1 wherein the sheets are cut in lozenge shape before pressing to compensate for the contraction produced by the pressing.

6. Process in accordance with claim 1 wherein the sheets are made from a continuous strip of cardboard extending in the direction of the contraction produced by the pressing and are cut from the strip after pressing.

7. Screening and humidifying panel in particular for avicultural facilities or greenhouses and formed from cardboard sheets shaped by pressing with non-rectilinear undulated channels and glued together arranged with different mutual alternating inclination of the channels.

8. Panel in accordance with claim 7 wherein each channel has end sections near the sheet edges which constitute inlet and outlet sides of the panel and which are virtually at a right angle to said edges and inclined sections for connection of said end sections.

9. Panel in accordance with claim 7 wherein each channel has end sections near the sheet edges which will constitute inlet outlet sides of the panel and which are inclined with respect to said edges and sections virtually at a right angle to said edges and which are for connection of said end sections.

10. Press for obtaining deformed cardboard sheets for manufacturing screening and humidifying panels in particular for avicultural facilities or greenhouses and comprising a die made up of a plurality of segments each representing at least part of a channel and moving sequentially to press the cardboard starting from one end of the press.

11. Press in accordance with claim 10 wherein the segments of the plurality are supported elastically on a moving press table to press sequentially the cardboard upon operation of the moving press table.
